(19) United States
(12) Patent Application Publication
(10) Pub. No.: US 2010/0051887 A1
(43) Pub. Date: Mar. 4, 2010

(54) WIRE STRAINER

(75) Inventors: MAURICE WILLIAM WOOSTER, UPPER HUTT (NZ); BRIAN EDWARD COLLINS, UPPER HUTT (NZ)

Correspondence Address: YOUNG & THOMPSON, 209 Madison Street, Suite 500, Alexandria, VA, 22314, US

(73) Assignee: ROBERTSON ENGINEERING LIMITED, UPPER HUTT (NZ)

(21) Appl. No.: 12/546,058

(22) Filed: Aug. 24, 2009

(30) Foreign Application Priority Data
Aug. 27, 2008 (NZ) 570800

(51) Int. Cl. B25B 25/00; F16G 11/12; E04H 17/02; B21F 9/00; B21F 9/02

(52) U.S. Cl. 254/217; 242/396.4

(57) ABSTRACT

A wire strainer has a ratcheted spool rotatably attached to a frame to rotate in a desired direction when tensioning and able to freewheel otherwise. At least one oval/elliptical hole in the shaft accommodates one, two or more wires therein in a particular orientation on the shaft. The oval/elliptical hole is adapted to be dimensioned and positioned on the shaft such that the integrity and strength of the shaft is not compromised or lessened. A projection and a two plane guide means can be situated on the spool whereby the projection is positioned and engages with a portion of a wire and the two plane guide is positioned and assists in deflecting the length of wire not engaged with the projection away from the projection as the spool is rotated during the straining of a wire. Y-shaped reinforcing ribs on the frame provide strengthening and rigidity while tensioning.

### FIELD OF INVENTION

The invention relates to a wire strainer, typically an in-line wire strainer.

### BACKGROUND OF INVENTION

The wire straining of wire fences prior to the 1970's generally used to be an arduous and a complicated task and if not done correctly could lead to the integrity of the fence being compromised. Also over a period of time the strain on the wires lessened and restraining of the fence involved to having to cut the wire to restrain.

Since about the 1970's alternative wire strainers utilising a ratchet and toothed spool arrangement have been widely used. These types of strainers are permanently attached to the wire of the fence thus allowing the fence to be restrained when required. However not all these are true in line wire strainers as they usually involve having to tie one wire to the frame of the wire strainer and the other wire attached to the spool prior to wire straining.

Since about 2000 it has been known to have a wire strainer with a hole in the apex of the wire strainer, in which there is no requirement to tie a wire to the wire strainer as a single continuous length of wire can be used by threading the wire through the hole in the apex and through a hole in the spool of the wire and then straining wire by winding the spool.

### OBJECT OF THE INVENTION

It is an object of the invention to provide a wire strainer that ameliorates some of the disadvantages and limitations of the known art or at least provide the public with a useful choice.

### SUMMARY OF INVENTION

In a first aspect the invention resides in a wire strainer, typically an in-line wire strainer, for straining a fence wire, the wire strainer includes:
i. a frame;
ii. a spool rotatably mounted to the frame;
iii. ratchet means adapted to selectively allow the spool to rotate only in a desired direction when the wire is to be tensioned and/or retained in a tensioned state and able to free wheel when the wire is not required to be in a tensioned state; and
iv. a spool shaft having at least one oval/elliptical hole therein adapted to accommodate one, two or more wires therein in a particular orientation on the shaft, the oval/elliptical hole is adapted to be dimensioned and positioned on the shaft such that the integrity and strength of the shaft is not compromised or lessened.

In a second aspect the invention resides in a wire strainer, typically an in-line wire strainer, for straining a fence wire, the wire strainer includes:
i. a frame;
ii. a spool rotatably mounted to the frame
iii. ratchet means adapted to selectively allow the spool to rotate only in a desired direction when the wire is to be tensioned and/or retained in a tensioned state and able to free wheel when the wire is not required to be in a tensioned state; and
iv. wire guide situated on the frame, the wire guide is spaced away from the spool such that the wire guide assist in aligning the wire on to the spool.

In a third aspect the invention resides in a wire strainer, typically an in-line wire strainer, for straining a fence wire, the wire strainer includes:
i. a frame;
ii. a spool having a shaft rotatably mounted to the frame,
iii. ratchet means adapted to selectively allow the spool to rotate only in a desired direction when the wire is to be tensioned and/or retained in a tensioned state and able to free wheel when the wire is not required to be in a tensioned state; and
iv. a projection and a two plane guide means situated on the spool, the projection is positioned and adapted to engage with a portion of a wire and the two plane guide means is positioned and adapted to assist in deflecting the length of wire not engaged with the projection away from the projection as the spool is rotated during the straining of a wire.

In a fourth aspect the invention resides in a wire strainer, typically an in-line wire strainer, for straining a fence wire, the wire strainer includes:
i. a frame;
ii. a spool rotatably mounted to the frame
iii. ratchet means adapted to selectively allow the spool to rotate only in a desired direction when the wire is to be tensioned and/or retained in a tensioned state and able to free wheel when the wire is not required to be in a tensioned state; and
iv. Y-shaped reinforcing ribs situated on the frame adapted to provide strengthening and rigidity to the frame when under tension.

In a fifth aspect the invention resides in a wire strainer, typically an in-line wire strainer, for straining a fence wire, the wire strainer includes:
i. a frame; and
ii. a spool rotatably mounted to the frame, the spool having at least one toothed flange with eleven equally spaced apart teeth so as to allow for finer adjustment increments of 32.7 degrees per tooth to provide accurate and flexibility of the rotation of the spool when straining a wire.

In a sixth aspect the invention resides in a wire strainer, typically an in-line wire strainer, for straining a fence wire, the wire strainer includes:
i. a frame;
ii. a spool rotatably mounted to the frame; and
iii. ratchet mechanism adapted to selectively allow the spool to rotate only in a desired direction when the wire is to be tensioned and/or retained in a tensioned state and to free wheel when the wire is not under tension, the ratchet mechanism consists of at least one toothed flange attached to the spool, at least one locking notch on the frame and a pivotal biasing means adapted to engage with a tooth of the toothed flange and engage with the locking notch when the ratchet mechanism is selected to allow the spool to rotate in said desired direction when the wire is under tension, the ratchet mechanism when selected to allow the spool to rotate in one said desired direction is such that whilst under strained tension the locking notch assists in locking the biasing means to the frame in order to provide rigidity to the wire strainer by preventing the spring and the spool from disengaging from the frame.

In a seventh aspect the invention resides in a wire strainer, typically an in-line wire strainer, for straining a fence wire, the wire strainer includes a spool rotatably attached to a frame, the spool includes:
i. a shaft adapted to allow wire to be wound thereabout;
ii. at least one toothed flange attached to the shaft;
iii. a projection and two plane guide means adapted to allow a wire to be wound and guided on the spool; and/or
iv. at least one oval/elliptical aperture on the shaft adapted to accommodate one, two or more wires therein in a particular orientation on to the shaft; and/or
v. eleven equally spaced apart teeth on the toothed flange so as to allow for finer adjustment increments of 32.7 degrees per tooth to provide accurate and flexibility of the rotation of the spool when straining a wire.

Preferably, the oval/elliptical aperture is a hole that extends all the way trough the shaft.

In an eight aspect the invention resides in a wire strainer, typically an in-line wire strainer, for straining a fence wire, having a spool rotatably attached to a frame, the wire strainer includes at least one or any combination of the following:
i. the spool having a shaft rotatably mounted to the frame;
ii. ratchet means adapted to selectively allow the spool to rotate only in a desired direction when the wire is to be tensioned and/or retained in a tensioned state and able to free wheel when the wire is not required to be in a tensioned state;
iii. at least one oval/elliptical hole in the shaft adapted to accommodate one, two or more wires therein in a particular orientation on the shaft, the oval/elliptical hole is adapted to be dimensioned and positioned on the shaft such that the integrity and strength of the shaft is not compromised or lessened;
iv. wire guide situated on the frame, the wire guide is spaced away from the spool such that the wire guide assist in aligning the wire on to the spool;
v. a projection and a two plane guide means situated on the spool, the projection is positioned and adapted to engage with a portion of a wire and the two plane guide means is positioned and adapted to assist in deflecting the length of wire not engaged with the projection away from the projection as the spool is rotated during the straining of a wire;
vi. Y-shaped reinforcing ribs situated on the frame adapted to provide strengthening and rigidity to the frame when under tension; and
vii at least one toothed flange mounted to the shaft of the spool the toothed flange having eleven equally spaced apart teeth so as to allow for finer adjustment increments of 32.7 degrees per tooth to provide accurate and flexibility of the rotation of the spool when straining a wire.

Preferably, the frame is an open mouthed frame with elongate sides that extend backwards away from the open mouth and converge and connect to one another to form an apex end portion, and each side of the frame a spool shaft accommodating aperture adapted to accommodate the shaft of the spool.

Preferably, the apex end portion includes the wire guide and two transverse facing side apertures and a rear facing aperture, the rear facing aperture is aligned to be co-axial and/or parallel to the longitudinal axis of the frame so as to allow a wire to extend through the hole in a longitudinal direction in the wire toward the spool.

Preferably, the spool has a shaft with two spaced apart flanges; one of said flanges has on its inner surface the projection and two plane guide means.

Preferably, each Y-shaped reinforcing rib is a continuous rib.

Preferably, the ratchet means is a ratchet mechanism adapted to selectively allow the spool to rotate only in a desired direction when the wire is to be tensioned and/or retained in a tensioned state and to free wheel when the wire is not under tension, the ratchet mechanism consists of at least one toothed flange attached to the spool, at least one locking notch on the frame and a pivotal biasing means adapted to engage with a tooth of the toothed flange and engage with the locking notch when the ratchet mechanism is selected to allow the spool to rotate in said desired direction when the wire is under tension, the ratchet mechanism when in the selected to allow the spool to rotate in one said desired direction is such that whilst under strained tension the locking notch assists in locking the biasing means to the frame in order to provide rigidity to the wire strainer by preventing the spring and the spool from disengaging from the frame.

In other aspects herein described

### BRIEF DESCRIPTION

The invention will now be described, by way of example only, by reference to the accompanying drawings:

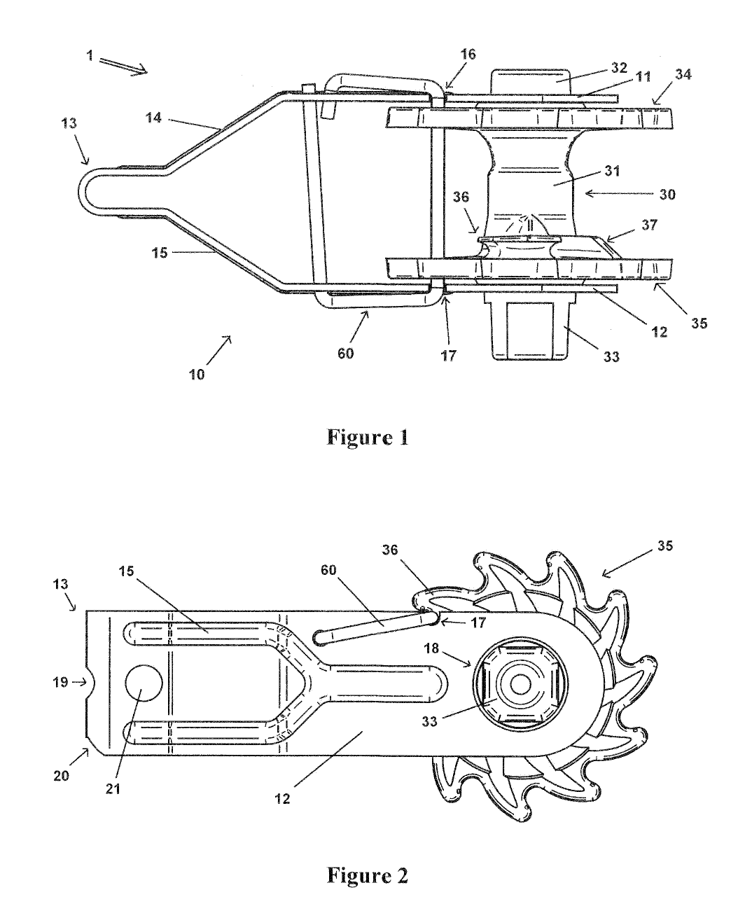

FIG. 1 is a top view of a wire strainer in accordance with a preferred embodiment of the invention.

FIG. 2 is a side view of a wire strainer as shown in FIG. 1.

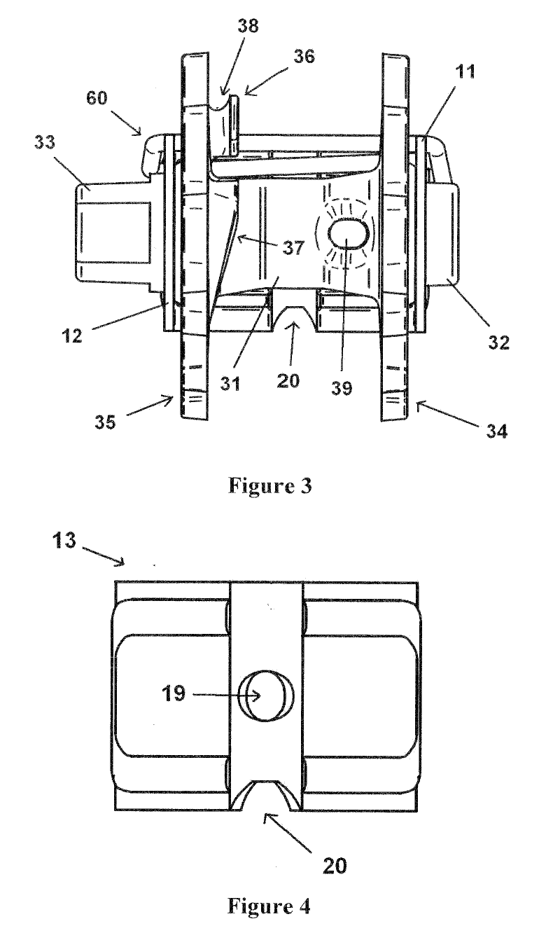

FIG. 3 is a front view of a wire strainer as shown in FIG. 1.

FIG. 4 is a back view of a wire strainer (without the spool shown) as shown in FIG. 1.

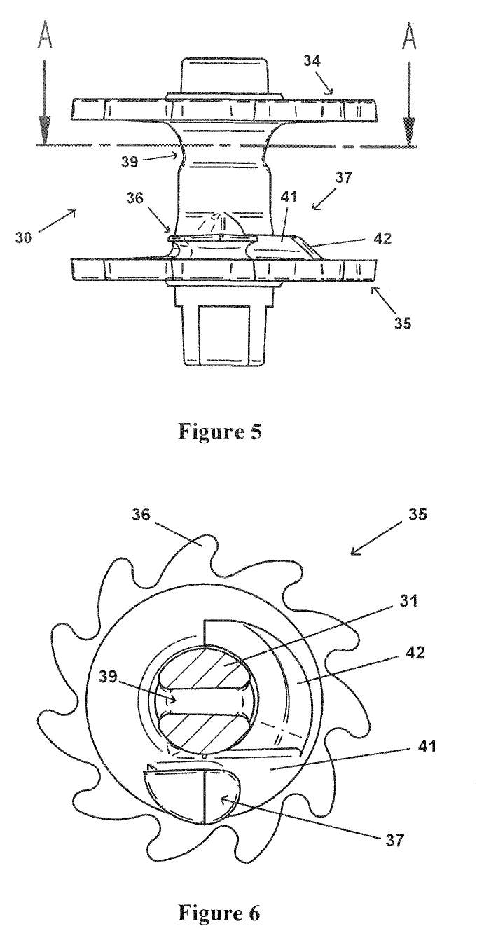

FIG. 5 is a top view of the spool as shown in FIG. 1.

FIG. 6 is a cut-away view along A-A of the spool shown in FIG. 5

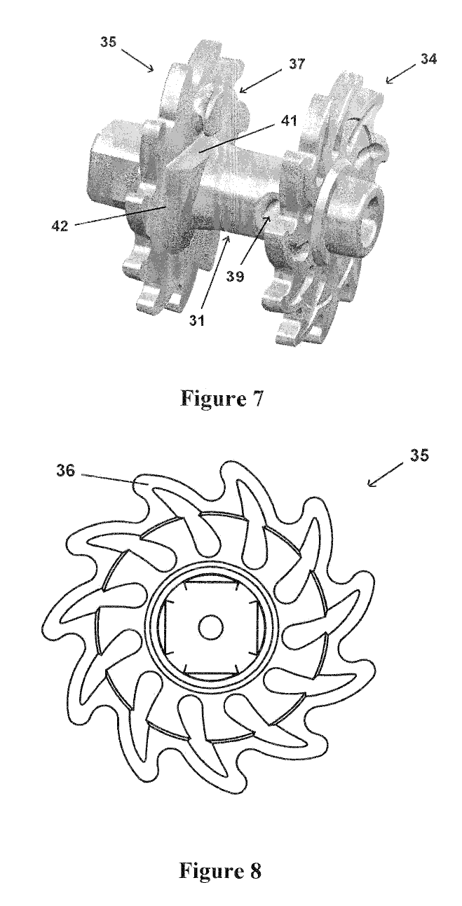

FIG. 7 is a perspective view of the spool shown in FIG. 5

FIG. 8 is a side view of the spool shown in FIG. 5.

### DESCRIPTION OF DRAWINGS

The following description will describe the invention in relation to preferred embodiments of the invention, namely a wire strainer. The invention is in no way limited to these preferred embodiments as they are purely to exemplify the invention only and that possible variations and modifications would be readily apparent without departing from the scope of the invention.

The invention will now be described firstly with reference to FIGS. 1 to 4 a possible embodiment of the invention, Wire strainer 1 consists of an open mouthed frame with sides 11, 12 that extend backwards converging to an apex 13. Each side 11, 12 of the frame 10 has an spool shaft accommodating an aperture 18 that accommodates and allow respective end parts 32, 33 of the spool shaft 30 to extend outwardly therethrough. A toothed spool is rotatably mounted to and within the apertures 18 in the respective sides 11, 12 of the frame 10. The spool has spaced apart flanges 34, 35 with teeth 36. End part 33 is suitably shaped to assist in the winding of the spool by a suitably corresponding tool.

The wire strainer has a ratchet type arrangement that allows the spool to wind only in a one direction, namely a winding up direction, when the ratchet type arrangement is activated and allows the spool to ‘free wheel’ in any direction when the ratchet type arrangement is not activated. In the embodiment shown the ratchet type arrangement consists of the teeth 36 of the spool flanges 34, 35, a spring 60 and notches 16, 17 in the frame sides 11, 12. The spring 60 is pivotally attached to and positioned on the frame such that in an activated ratchet state the spring engages with a tooth 36 and the notches 16, 17 such that the spool is unable to unwind (see FIG. 2), but still able to wind. The locking notches 16, 17 in the frame 10 of the wire strainer 1 houses therein a portion of the spring 60 such that the teeth 36 of the spool force the spring into the locking notches 16, 17 in order to lock and prevent the spool to rotate (in a particular direction) when the wire strainer 1 is under strained tension. Whilst under strained tension the locking notches 16, 17 effectively assist in locking the spring 60 to the frame 10 which in turn provides rigidity to the wire strainer 1 by preventing the spring and the spool from disengaging from the frame. Also the locking notches 16, 17 in combination with the spool and the spring effectively provide a locking mechanism securing the frame together when the strainer is used inline, (without the wire tied to the frame). When other known inline strainers are used without the wire tied to the frame the frame can have the tendency to splay apart allowing the spring and or spool to disengage causing loss of wire tension.

The wire strainer 1 includes reinforcing ribs 14, 15 on each side 11, 12 of the frame and the reinforcing ribs extend from an area adjacent to the aperture 18 back toward the apex 13 of the frame. As shown in FIG. 2 the reinforcing ribs 14, 15 are “Y” shaped in order to provide strengthening ribs that provide rigidity to the frame 10 when under tension. The shape allows for a continuous rib, whilst also allowing clearance for the wire spring 60.

The apex portion 13 of the wire strainer will now be described. The apex portion of the frame consists two side wire engaging apertures 21 (only one shown—see FIG. 2) that extend transversely relative to the longitudinal axis of the frame 10. The wire engaging apertures 21 allow one end of a fence wire connected to a post to be attached by passing the wire through the apertures and tied back on itself in the usual known manner. The apex portion 13 also has an in-line aperture 19 situated at the apex of the apex portion 13 and the in-line aperture 19 is aligned to be co-axial and/or parallel to the longitudinal axis of the frame 10. Preferably the in-line aperture 19 substantially lies in the same plane as the spool. The in-line aperture 19 is such that it can allow the wire strainer 1 to be used in connecting two wires together as a true in-line wire strainer, for example, each wire is attached to a post and the free ends of the wire are attached to the wire strainer 1 whereby one end of wires is attached to the spool by passing the free end of the wire through the in-line aperture 19 and the free end of the other wire is attached directly to the spool and then the wire strainer is strained in the usual manner. However the most preferred use of the in-line aperture 19 is with only one continuous wire extending between two posts. In this particular scenario one end of the wire is attached to a post and the other end of the wire is threaded through in-line aperture 19 and then attached to the spool (by known methods such as, but not limited to, winding the wire about the spool, passing through an aperture in the shaft of the spool or affixing to a projection on the spool) and then tying the wire to the other post.

The apex portion 13 also includes a wire guide 20 situated at either the top or bottom of the apex portion 13. In FIGS. 2 & 4 the wire guide is shown in its preferred position at the bottom, but it is envisaged that the guide could equally be positioned at the top. The purpose of the wire guide 20 is to assist the wire on to and in association with the spool such that the wire guide 20 orientates the wire on the correct side of the wire strainer 1. During straining of the wire, the wire guide 20 guides the wire keeps the strainer frame in line with the wire, thus reducing the tendency for the strainer to twist out of line during in line straining (i.e. when used without tying the wire to the strainer). The wire guide is of assistance and real benefit when use in combination with a spool having a wire engaging lug 36. The wire guide 20 allows for a more simplified tightening operation and can prevent injury and slippage and does not require the wire to be tied to the wire strainer 1.

The invention will now be described in respect of the spool as shown in FIGS. 3, 5, 6 & 7. The spool is shown having a wire engaging portion, lug 36 and a two plane ramp 37. The lug is situated on inside facing surface of the spool flange 35 and is spaced a distance above shaft 31 of the spool. The lug has a wire engaging groove 38 to assist in retaining a portion of a wire therein as the wire is being strained. The two plane ramp 37 is situated on the flange 35 spaced a distance from the lug 36 such that a wire is able to lie within the spaced distance. The two plane ramp 37 has a flat portion 41 and a tapered portion 42 the plane of which lies at an angle, e.g. substantially perpendicular, plane to the flat portion 41 such that both the flat and tapered portions assist in deflecting the wire away from the lug as the wire is being strained. The lug 36 and two plane ramp 37 along with the wire guide 20 (on the apex portion 13) provides a mechanism to utilize the strainer in an inline option without cutting the wire to thread through the frame. The addition of a lug 36 with a two plane ramp 37 on the spool provides a mechanism to effectively deflect the wire from riding up over the lug feature. This is in contrast to a wire strainer having only a single plane ramp which does not provide a consistently effective means to deflect the wire. In use the lug 36, two plane ramp 37 and wire guide 20 allows the wire strainer to be used on an existing fence wire extending between two posts with out having to cut the wire or thread the wire strainer on to the wire. The wire strainer 1 is positioned such that a portion of the wire is positioned in and engaged with the wire engaging groove 38 in the lug 36 and a portion of the wire downstream of the lug is situated and engaged within the wire guide 20 of the apex portion 13. In this position the wire strainer 1 is attached to the wire in the correct alignment position and is unable to readily fall off. Once in position the wire is able to be strained in the usual manner by rotating the spool (in the backward winding direction). As the spool rotates the wire is caused by the lug 36 to pass over the flat portion 41 of the two plane ramp 37 and then upon further rotation is caused by the tapered ramp 42 to deflect away from the lug 36 and extend about the shaft 31 of the spool. The guide 20 in the apex keeps the wire strainer in correct alignment on the wire as it being strained.

The shaft 31 of the spool includes at least one wire engaging aperture 39. The aperture 39 is preferably oval/elliptical in shape and the largest diametrical extent of the aperture 39 extends along the longitudinal axis of the shaft 31. The oval/elliptical hole has is dimensioned such that at least two wires can be positioned therein side by side, preferably side by side along the longitudinal axis of the shaft 31. The oval/elliptical aperture 39 holds one or two or more wires in a particular orientation, side by side, with respect to one another and in relation to the axis of the spool shaft 31, whilst retaining the cross sectional area and subsequent strength of the shaft 31 by that provided by the minor dimension of the oval/elliptical aperture. Whereas a larger dimensioned round hole does not provide the same advantage, although it could also hold two wires, it does not dictate the particular orientation with respect to one another and the axis of the spool axle and also the cross sectional area will be significantly reduced, compromising the strength of the spool shaft. The oval/elliptical hole 39 with its long dimension minimises the effect such an aperture has with respect to the shaft 31 (c.f. that to a round aperture of a diameter equal to the longest diameter of the oval/elliptical aperture) due to the smaller volume of the oval/elliptical aperture 39. Further, the oval/elliptical nature of the aperture holds the two or more wires in a particular orientation with respect to one another, which a round aperture does not.

Turning to FIG. 8 which shows a preferred flange 35 of the spool having eleven teeth 36. This spool has eleven teeth per flange as opposed to other similar existing wire strainers that have only ten teeth. An eleven tooth flange is compact in size and allows for finer adjustment increments of 32.7 degrees per tooth (c.f. ten tooth flange has 36 degree adjustment per tooth) that results in greater flexibility, aiding accuracy for achieving recommended wire tensions.

A wire strainer having all or a combination of features as described provide wire strainer that has improved flexibility, versatility and handling compared with the known wire strainers.

### ADVANTAGES

a) Easy to use.
b) Multi functional
c) More accurate wire tension being achieved
d) Able to be used on pre-existing fences without having to cut and or tie to wire.
e) Better and accurate alignment of wire strainer on the fence wire

### VARIATIONS

Throughout the description of this specification, the word “comprise” and variations of that word such as “comprising” and “comprises”, are not intended to exclude other additives, components, integers or steps.

It will of course be realised that while the foregoing has been given by way of illustrative example of this invention, all such and other modifications and variations thereto as would be apparent to persons skilled in the art are deemed to fail within the broad scope and ambit of this invention as is substantially herein defined in the appended claims.

1-18. (canceled)

19. A wire strainer for straining a fence wire, wherein the wire strainer includes:
i. a frame;
ii. a spool rotatably mounted to the frame;
iii. ratchet means adapted to selectively allow the spool to rotate only in a desired direction when the wire is to be tensioned and/or retained in a tensioned state and able to free wheel when the wire is not required to be in a tensioned state; and
iv. a spool shaft having at least one oval/elliptical hole therein adapted to accommodate one, two or more wires therein in a particular orientation on the shaft, the oval/elliptical hole is adapted to be dimensioned and positioned on the shaft such that the integrity and strength of the shaft is not compromised or lessened.

20. A wire strainer for straining a fence wire, wherein the wire strainer includes:
i. a frame;
ii. a spool having a shaft rotatably mounted to the frame,
iii. ratchet means adapted to selectively allow the spool to rotate only in a desired direction when the wire is to be tensioned and/or retained in a tensioned state and able to free wheel when the wire is not required to be in a tensioned state; and
iv. a projection and a two plane guide means situated on the spool, the projection is positioned and adapted to engage with a portion of a wire and the two plane guide means is positioned and adapted to assist in deflecting the length of wire not engaged with the projection away from the projection as the spool is rotated during the straining of a wire.

21. A wire strainer for straining a fence wire, wherein the wire strainer includes:
i. a frame;
ii. a ratchet means adapted to selectively allow the spool to rotate only in a desired direction when the wire is to be tensioned and/or retained in a tensioned state and able to free wheel when the wire is not required to be in a tensioned state; and
iii. a spool rotatably mounted to the frame, the spool having at least one toothed flange with eleven equally spaced apart teeth so as to allow for finer adjustment increments of 32.7 degrees per tooth to provide accurate and flexibility of the rotation of the spool when straining a wire.

22. A wire strainer for straining a fence wire, having a spool rotatably attached to a frame, wherein the spool includes:
i. a shaft adapted to allow wire to be wound thereabout;
ii. a ratchet means adapted to selectively allow the spool to rotate only in a desired direction when the wire is to be tensioned and/or retained in a tensioned state and able to free wheel when the wire is not required to be in a tensioned state;
iii. at least one toothed flange attached to the shaft;
iv. a projection and two plane guide means adapted to allow a wire to be wound and guided on the spool; and/or
v. at least one oval/elliptical aperture on the shaft adapted to accommodate one, two or more wires therein in a particular orientation on to the shaft; and/or
vi. eleven equally spaced apart teeth on the toothed flange so as to allow for finer adjustment increments of 32.7 degrees per tooth to provide accurate and flexibility of the rotation of the spool when straining a wire.

23. A wire strainer, typically an in-line wire strainer, for straining a fence wire, having a spool rotatably attached to a frame, wherein the wire strainer includes at least one or any combination of the following:
i. the spool having a shaft rotatably mounted to the frame;
ii. ratchet means adapted to selectively allow the spool to rotate only in a desired direction when the wire is to be tensioned and/or retained in a tensioned state and able to free wheel when the wire is not required to be in a tensioned state;
iii. at least one oval/elliptical hole in the shaft adapted to accommodate one, two or more wires therein in a particular orientation on the shaft, the oval/elliptical hole is adapted to be dimensioned and positioned on the shaft such that the integrity and strength of the shaft is not compromised or lessened;
iv. wire guide situated on the frame, the wire guide is spaced away from the spool such that the wire guide assists in aligning the wire on to the spool;
v. a projection and a two plane guide means situated on the spool, the projection is positioned and adapted to engage with a portion of a wire and the two plane guide means is positioned and adapted to assist in deflecting the length of wire not engaged with the projection away from the projection as the spool is rotated during the straining of a wire;
vi. Y-shaped reinforcing ribs situated on the frame adapted to provide strengthening and rigidity to the frame when under tension; and
vii. at least one toothed flange mounted to the shaft of the spool, the toothed flange having eleven equally spaced apart teeth so as to allow for finer adjustment increments of 32.7 degrees per tooth to provide accurate and flexibility of the rotation of the spool when straining a wire.

24. The wire strainer as claimed in claim 19 wherein the wire strainer includes at least one Y-shaped reinforcing ribs situated on the frame adapted to provide strengthening and rigidity to the frame when under tension.

25. The wire strainer as claimed in claim 24 wherein there are two Y-shaped reinforcing ribs situated on the frame, where one Y-shaped reinforcing ribs situated on one side of the frame and the other on another side of the frame whereby the two—Y shaped reinforcing ribs are spaced apart from one another.

26. The wire strainer as claimed in claim 19 wherein the wire strainer includes a wire guide situated on the frame, the wire guide is spaced longitudinally away from the spool such that the wire guide assists in aligning the wire on to the spool.

27. The wire strainer as claimed in claim 19, wherein the ratchet means includes at least one toothed flange attached to the spool, at least one locking notch on the frame and a pivotal biasing means adapted to engage with a tooth of the toothed flange and engage with the locking notch when the ratchet mechanism is selected to allow the spool to rotate in said desired direction when the wire is under tension, the ratchet mechanism when selected to allow the spool to rotate in one said desired direction is such that whilst under strained tension the locking notch assists in locking the biasing means to the frame in order to provide rigidity to the wire strainer by preventing the spring and the spool from disengaging from the frame.

28. The wire strainer as claimed in claim 19, wherein the wire strainer is an in-line wire strainer.

29. The wire strainer as claimed in claim 19, wherein the frame is an open mouthed frame with elongate sides that extend backwards away from the open mouth and converge and connect to one another to form an apex end portion, and each side of the frame has a spool shaft accommodating aperture adapted to accommodate the shaft of the spool.

30. The wire strainer as claimed in claim 29, wherein the apex end portion includes two transverse facing side apertures and a rear facing aperture, the rear facing aperture is aligned to be co-axial and/or parallel to the longitudinal axis of the frame so as to allow a wire to extend through the rear facing aperture in a longitudinal direction toward the spool.

31. The wire strainer as claimed in claim 20, wherein the spool has two spaced apart flanges on the shaft, one of said flanges has on its inner surface the projection and two plane guide means.

32. The wire strainer as claimed in claim 25, wherein each Y-shaped reinforcing rib is a continuous rib.

33. The wire strainer as claimed in claim 19, wherein the shaft has two elliptical holes, wherein each hole is spaced equally apart on the shaft.

34. The wire strainer as claimed in claim 29, wherein the apex portion includes the wire guide.

35. A wire strainer as substantially hereinbefore described with reference to the accompanying drawings.

36. An inline wire strainer as substantially hereinbefore described with reference to the accompanying drawings

37. The wire strainer as claimed in claim 20 wherein the wire strainer includes at least one Y-shaped reinforcing ribs situated on the frame adapted to provide strengthening and rigidity to the frame when under tension.

38. The wire strainer as claimed in claim 21 wherein the wire strainer includes at least one Y-shaped reinforcing ribs situated on the frame adapted to provide strengthening and rigidity to the frame when under tension.
